(19) United States
(12) Patent Application Publication
(10) Pub. No.: US 2024/0026155 A1
(43) Pub. Date: Jan. 25, 2024

(54) Polyamideimide Film and Optical Multilayer Structure Comprising the Same

(71) Applicants: SK Innovation Co., Ltd., Seoul (KR); SK ie technology Co., Ltd., Seoul (KR)

(72) Inventors: Byung Guk Kim, Daejeon (KR); Jin Su Park, Daejeon (KR); Sun Kug Kim, Daejeon (KR); Sang Yoon Park, Daejeon (KR); Hyun Suk Chung, Daejeon (KR)

(21) Appl. No.: 18/212,820

(22) Filed: Jun. 22, 2023

(30) Foreign Application Priority Data
Jul. 12, 2022 (KR) 10-2022-0085408

(51) Int. Cl. C08L 79/08; G02B 1/04; G02B 1/14; G02B 1/111; C08K 5/3475; C08J 7/046

(52) U.S. Cl. CPC C08L 79/08; G02B 1/04; G02B 1/14; G02B 1/111; C08K 5/3475; C08J 7/046; C08L 2203/16; C08L 2201/08; C08L 2201/10; C08J 2379/08

(57) ABSTRACT

A polyamideimide film including a polyamideimide resin including units derived from dianhydride, aromatic diamine, and aromatic diacid dichloride; and a UV blocker including a benzotriazole-based compound is provided. The polyamideimide film according to one embodiment has UV weather resistance for a long time, low haze and a low yellow index, and a high modulus, so that optical and mechanical properties may be simultaneously implemented.

### CROSS-REFERENCE TO RELATED APPLICATION

This application claims priority to Korean Patent Application No. 10-2022-0085408 filed Jul. 12, 2022, the disclosure of which is hereby incorporated by reference in its entirety.

### BACKGROUND OF THE INVENTION

### Field of the Invention

The following disclosure relates to a polyamideimide film comprising a benzotriazole-based UV blocker and an optical multilayer structure comprising the same.

### Description of Related Art

In general, a polyimide-based resin has been applied to various fields, comprising insulating substrates for forming circuits and devices, due to its mechanical and thermal properties. Recently, research into and development of a technology of replacing cover glass for a display with polymer materials using these properties have been conducted.

However, the polyimide-based resin may be colored brown or yellow due to the formation of charge transfer complexes between aromatic rings during a polymerization process. As a result, light transmittance in a visible light region is lowered, making it difficult to apply it to display materials.

Therefore, optical and mechanical properties are required in order to use the polyimide-based resin for display. In particular, it is important to reduce the rate of change in color difference of a window by adjusting the light transmittance in the visible light region to be high and the light transmittance in a short wavelength region to be low in order to improve the weather resistance of a film by ultraviolet light due to the nature of a display cover window exposed to an environment.

On the other hand, a polyimide film having a high light transmittance in the visible light region also has a high light transmittance in a short wavelength region of about 400 nm or less. Accordingly, there was a problem in that a laminated structure under the display comprising the polyimide film was damaged by the ultraviolet light when exposed to the ultraviolet light. In order to solve this problem, efforts have been made to use some UV absorbers or UV stabilizers, but polyimide is processed at a high temperature, making it difficult to use additives, and even if it is used, there is a limit in that a yellow index increased.

### SUMMARY OF THE INVENTION

An embodiment is directed to providing a polyamideimide film that comprises a UV blocker and has high UV weather resistance, low yellow index, and/or high mechanical properties (modulus) by adjusting a light transmittance in a visible light region to be high and a light transmittance in a short wavelength region to be low.

Another embodiment is directed to providing an optical multilayer structure comprising a polyamideimide film as disclosed herein and a hard coating layer formed on the polyamideimide film.

Yet another embodiment is directed to providing a cover window for a display comprising an optical multilayer structure disclosed herein.

In one general aspect, there is provided a polyamideimide film having good UV weather resistance, optical properties, such as haze and a yellow index, and/or mechanical properties, such as a modulus, and in some embodiments, the polyamideimide film comprises: a polyamideimide resin comprising units derived from dianhydride, aromatic diamine, and aromatic diacid dichloride; and a UV blocker comprising a benzotriazole-based compound.

In another general aspect, there is provided an optical multilayer structure comprising the polyamideimide film as described above and a hard coating layer formed on the polyamideimide film.

In another general aspect, there is provided a cover window for a display comprising the optical multilayer structure as described above.

### BRIEF DESCRIPTION OF THE DRAWING

FIG. 1 is a graph showing the results of measuring a rate of change in color difference (ΔE) while irradiating ultraviolet light for a long time to optical multilayer structures according to Examples 1 to 3, Example 7, Comparative Example 1, and Comparative Example 2.

### DESCRIPTION OF THE INVENTION

The embodiments described in the specification may be modified in many different forms, and the technology according to one embodiment is not limited to the exemplary embodiments described below. Furthermore, unless explicitly described otherwise, “comprising”, “including” or “containing” any components throughout the specification will be understood to imply the inclusion of other components but not the exclusion of any other components.

Unless the context clearly indicates otherwise, the singular forms of the terms used in the present specification may be interpreted as including the plural forms. As used herein, the singular form of “a”, “an”, and “the” include plural referents unless the context clearly states otherwise.

For the purposes of this specification, unless otherwise indicated, all numbers expressing quantities of ingredients, reaction conditions, dimensions, physical characteristics, and so forth used in the specification and claims are to be understood as being modified in all instances by the term “about.” Hereinafter, unless otherwise defined herein, “about” may be considered as a value within 30%, 25%, 20%, 15%, 10%, 5%, 3%, 2%, 1%, 0.5%, 0.1%, or 0.01 of the specified value. Unless indicated to the contrary, the numerical parameters set forth in the following specification and attached claims are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Numerical ranges used herein comprise a lower limit, an upper limit, and all values within that range, increments that are logically derived from the type and width of the defined range, all double-defined values, and all possible combinations of upper and lower limits of numerical ranges defined in different forms. As an example, when the content of the composition is limited to 10% to 80% or 20% to 50%, a numerical range of 10% to 50% or 50% to 80% should also be construed as being described herein. Unless otherwise defined herein, values outside the numerical range that may arise due to experimental errors or rounded values are also comprised in the defined numerical range.

Hereinafter, unless otherwise defined herein, the term “mixtures thereof” or “combinations thereof” may mean mixing or copolymerization of constituents.

Hereinafter, unless otherwise defined herein, “A and/or B” may mean an aspect comprising both A and B, and may mean an aspect selected from one of A or B.

Hereinafter, unless otherwise defined herein, a “polymer” may comprise oligomers and polymers, and in some embodiments its structure may comprise multiple repeats of units derived from low molecular weight molecules. In some embodiments, the polymer may be an alternating copolymer, a block copolymer, a random copolymer, a graft copolymer, a gradient copolymer, a branched copolymer, a crosslinked copolymer, or a copolymer comprising all of the above-mentioned polymers (e.g., a polymer comprising more than one monomer). In another aspect, the polymer may be a homopolymer (e.g., a polymer comprising one monomer).

Hereinafter, unless otherwise defined herein, a “polyamic acid” may refer to a polymer comprising a structural unit comprising an amic acid moiety, and “polyamideimide” may refer to a polymer comprising a structural unit comprising an amide moiety and an imide moiety.

Hereinafter, unless otherwise defined herein, “polyimide-based” may be used as a meaning comprising polyimide and/or polyamideimide.

Hereinafter, unless otherwise defined herein, a “polyamideimide film” may be a film comprising polyamideimide. In some embodiments, the polyamide-imide film may be manufactured, for example, by solution polymerization of dianhydride and diacid dichloride in a diamine solution to prepare polyamic acid, and then performing imidization, or by reacting diacid dichloride with diamine to prepare an oligomer, reacting the oligomer with diamine and dianhydride, and then performing imidization.

Hereinafter, unless otherwise defined herein, when an element such as a layer, a film, a thin film, a region, or a plate is referred to as being “on” another element, it may be directly on another element or there may be on another element with the other element interposed therebetween.

Unless otherwise defined herein, “substituted” means that a hydrogen atom in a compound is substituted with a substituent. For example, the substituent may be selected from deuterium, a halogen atom (F, Br, Cl, or I), a hydroxyl group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, phosphoric acid or a salt thereof, a C₁₋₃₀ alkyl group, a C₂₋₃₀ alkenyl group, a C₂-alkynyl group, a C₆₋₃₀ aryl group, a C₇₋₃₀ arylalkyl group, a C₁₋₃₀ alkoxy group, a C₁₋₂₀ heteroalkyl group, a C₃₋₂₀ heteroarylalkyl group, a C₃₋₃₀ cycloalkyl group, a C₃₋₁₅ cycloalkenyl group, a C₆₋₁₅ cycloalkynyl group, a C₂₋₃₀ heterocyclic group, and/or combination(s) thereof.

In order to use a polyimide-based resin and/or a polyimide-based film in a display, optical and mechanical properties are required. In particular, in the case of a display cover window exposed to an environment according to a panel structure, it is important to reduce a rate of change in color difference of a window by adjusting a light transmittance in a visible light region to be high and a light transmittance in a short wavelength region to be low in order to improve a weather resistance of a film by ultraviolet light.

For this purpose, efforts have been made to use some UV blocker, but in the case of a polyimide-based resin, thermal stability is important because it is prepared and manufactured at a high temperature of about 200° C. or more. However, it is difficult to use additives suitable for the polyimide-based resin, and if additives were used, there were limitations such as an increase in a yellow index and/or a decrease in modulus.

On the other hand, in some embodiments, optical properties such as haze, a yellow index, and/or mechanical properties such as a modulus may be simultaneously improved as well as UV weather resistance by using a benzotriazole compound in a polyamideimide resin comprising units derived from dianhydride, aromatic diamine, and aromatic diacid dichloride.

In some embodiments, there is provided a polyamideimide film comprising: a polyamideimide resin(s) comprising units derived from dianhydride(s), aromatic diamine(s) and aromatic diacid dichloride(s); and
a UV blocker comprising a benzotriazole-based compound.

In one embodiment, the benzotriazole-based compound(s) is not particularly limited as long as it is benzotriazole (C₆H₅N₃) or a derivative thereof. In some embodiments, the benzotriazole-based compound(s) may comprise any one or more of the following compounds A to F:

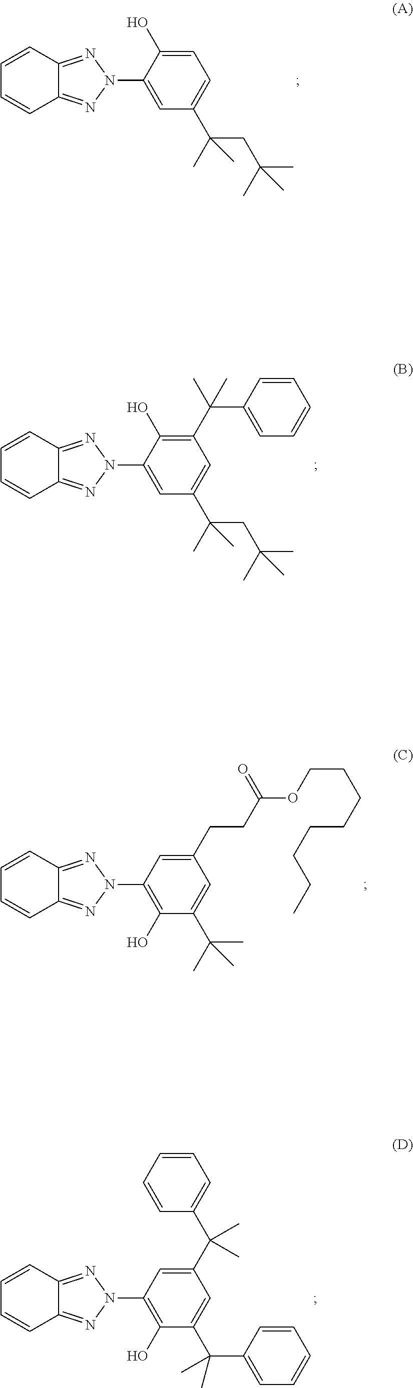 [SMILES: CC(C)(C)CC(C)(C)c1ccc(O)c(-n2nc3ccccc3n2)c1 ; CC(C)(C)CC(C)(C)c1cc(-n2nc3ccccc3n2)c(O)c(C(C)(C)c2ccccc2)c1 ; CCCCCCCCOC(=O)CCc1cc(-n2nc3ccccc3n2)c(O)c(C(C)(C)C)c1 ; CC(C)(c1ccccc1)c1cc(-n2nc3ccccc3n2)c(O)c(C(C)(C)c2ccccc2)c1]

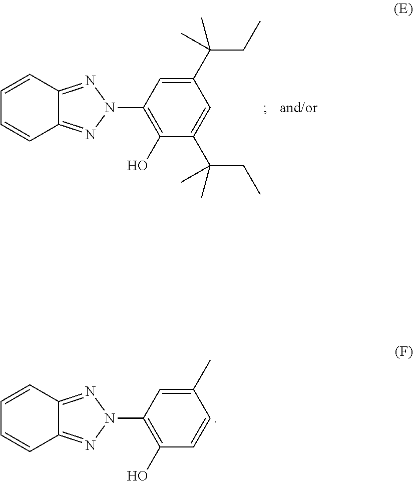 [SMILES: CCC(C)(C)c1cc(-n2nc3ccccc3n2)c(O)c(C(C)(C)CC)c1 ; Cc1ccc(O)c(-n2nc3ccccc3n2)c1]

A polyamideimide film according to some embodiments may comprise the benzotriazole-based compound(s) in combination with a polyamideimide resin(s) comprising units derived from dianhydride(s), aromatic diamine(s), and aromatic diacid dichloride(s) to excellently implement the desired UV weather resistance in one embodiment and simultaneously prevent degradation of haze, a yellow index, and/or a modulus, etc., which were limitations when conventional UV blockers were used.

The effect according to one embodiment is achieved only by combining the polyamideimide resin(s) according to one embodiment with a UV blocker(s) comprising a benzotriazole-based compound(s) (e.g., a compound necessarily containing at least one of Compounds A to F), and is a remarkable effect that cannot be achieved by combining with other existing UV blockers. As a specific example, when a UV blocker containing a benzophenone-based compound (e.g., 2,2′,4,4′-tetrahydroxylbenzophenone, 2,2′-dihydroxyl-4,4′-dimethoxybenzophenone, etc.) is used in combination with the polyamideimide resin according to one embodiment, the rate of change in color difference (ΔE) over time by ultraviolet light is significantly increased compared to the film of one embodiment, and the modulus and yellow index are degraded, so that it is not suitable for use in a display panel.

The benzotriazole-based compound(s) according to some embodiments may comprise any one or more of the following compounds A to C. Also, the benzotriazole-based compound according to one embodiment may be any one or more of the following compounds A to compounds C:

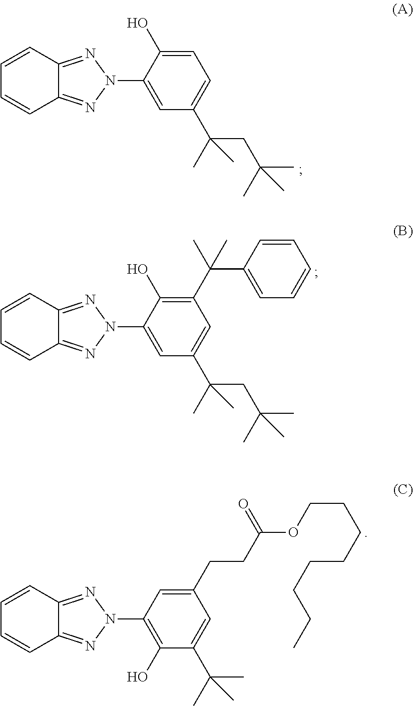 [SMILES: CC(C)(C)CC(C)(C)c1ccc(O)c(-n2nc3ccccc3n2)c1 ; CC(C)(C)CC(C)(C)c1cc(-n2nc3ccccc3n2)c(O)c(C(C)(C)c2ccccc2)c1 ; CCCCCCCCOC(=O)CCc1cc(-n2nc3ccccc3n2)c(O)c(C(C)(C)C)c1]

In the unit derived from aromatic diamine comprised in the polyamideimide resin according to one embodiment, the aromatic diamine may be diamine(s) comprising at least one aromatic ring, and may be, for example, 2,2-bis(3-amino-4-hydroxyphenyl)-hexafluoropropane (6FAP), p-phenylenediamine (pPDA), m-phenylenediamine (mPDA), p-methylenedianiline (pMDA), and/or m-methylenedianiline (mMDA).

In one embodiment, the aromatic diamine(s) may comprise fluorine-based aromatic diamine(s) (aromatic diamine(s) containing a fluorine atom). The fluorine-based aromatic diamine(s) is not particularly limited as long as it is a diamine compound(s) comprising a fluorine atom, and may be, for example, any one or more of 2,2′-bis(trifluoromethyl)benzidine (TFMB), 2,2-bis[4-(4-aminophenoxy)phenyl]hexafluoropropane (HFBAPP), 2,2-bis(4-aminophenyl)hexafluoropropane (BAHF), 2,2′-bis(trifluoromethyl)-4,4′-diaminodiphenylether, 4,4′-bis(4-amino-2-trifluoromethylphenoxy)biphenyl, 1,4-bis(4-amino-2-trifluoromethylphenoxy)benzene, and/or a derivative thereof.

In the unit derived from the dianhydride comprised in the polyamideimide resin according to one embodiment, the dianhydride(s) may comprise an aromatic dianhydride(s) and/or a cycloaliphatic dianhydride(s).

The aromatic dianhydride(s) may be a dianhydride(s) comprising at least one aromatic ring. The aromatic dianhydride(s) may comprise an aromatic dianhydride(s) commonly used in the technical field disclosed herein. The aromatic dihydride(s) may be, for example, any one or more of pyromellitic dianhydride (PMDA), 3,3′,4,4′-biphenyltetracarboxylic dianhydride (BPDA), 3,3′,4,4′-benzophenonetetracarboxylic dianhydride (BTDA), 4,4′-oxydiphthalic anhydride (ODPA), 4,4′-(4,4′-isopropylidenediphenoxy)bis(phthalic anhydride) (BPADA), 3,3′,4,4′-diphenylsulfone tetracarboxylic dianhydride (DSDA), 2,2′-bis-(3,4-dicarboxylphenyl) hexafluoropropane dianhydride (6FDA), ethylene glycol bis(4-trimellitate anhydride) (TMEG-100), p-phenylenebis(trimellitate anhydride) (TMHQ), 2.2′-bis(4-hydroxyphenyl)propanedibenzoate-3,3′,4,4′-tetracarboxylicdianhydride, (ESDA), 2,2-bis[4-(2,3-dicarboxyphenoxy)phenyl]propane), 4,4′-(3,4-dicarboxyphenoxy)diphenylsulfide dianhydride, naphthalenetetracarboxylic dianhydride (NTDA), and/or a derivative thereof. In some embodiments, the aromatic dianhydride may comprise 6FDA.

The cycloaliphatic dianhydride(s) may mean a dianhydride(s) comprising at least one aliphatic ring. The aliphatic ring may be a single ring, or a fused ring in which two or more aliphatic rings are fused, or an unfused ring in which two or more aliphatic rings are connected by a single bond, a substituted or unsubstituted C₁₋₅ alkylene group, or O or C(═O). The cycloaliphatic dianhydride(s) may comprise a cycloaliphatic dianhydride(s) commonly used in the art disclosed herein. The cycloaliphatic dianhydride(s) may be, for example, any one or more of 1,2,3,4-cyclobutanetetracarboxylic dianhydride (CBDA), 1,2,3,4-cyclopentanetetracarboxylic dianhydride (CPDA), 1,2,3,4-cyclohexanetetracarboxylic dianhydride (CHDA), 5-(2,5-dioxotetrahydrofuryl)-3-methyl-cyclohexane-1,2-dicarboxylic anhydride (DOCDA), bicyclo[2.2.2]-7-octene-2,3,5,6-tetracarboxylic dianhydride (BTA), 1,3-dimethyl-1,2,3,4-cyclobutanetetracarboxylic dianhydride (DM-CBDA), 1,3-diethyl-1,2,3,4-cyclobutanetetracarboxylic dianhydride (DE-CBDA), 1,3-diphenyl-1,2,3,4-cyclobutanetetracarboxylic dianhydride (DPh-CBDA), 4-(2,5-dioxotetrahydrofuran-3-yl)-1,2,3,4-tetrahydronaphthalene-1,2-dicarboxylic anhydride (TDA), and/or a derivative thereof. In some embodiments, the cycloaliphatic dianhydride may comprise CBDA.

In one embodiment, the cycloaliphatic dianhydride(s) may comprise one or more compounds represented by the following Formula 1:

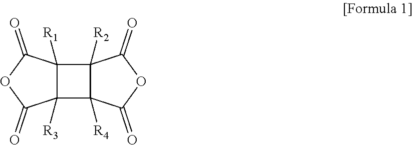

wherein R₁ to R₄ are each independently hydrogen, halogen, a C₁₋₂₀ alkyl group, a C₁₋₁₅ alkyl group, a C₁₋₁₀ alkyl group, a C₁₋₈ alkyl group, a C₁₋₈ alkyl group, a C₁₋₃ alkyl group, a C₁₋₁₀ alkoxy group, a C₁₋₈ alkoxy group, a Ci-s alkoxy group, or a C₁₋₃ alkoxy group.

In one embodiment, when the dianhydride(s) comprises both an aromatic dianhydride and a cycloaliphatic dianhydride, the aromatic dianhydride and cycloaliphatic dianhydride may be comprised in a molar ratio of 10:90 to 90:10, 20:80 to 80:20, 30:70 to 70:30, 40:60 to 60:40, 45:55 to 55:45, or about 50:50.

In the unit derived from aromatic diacid dichloride(s) comprised in the polyamideimide resin according to one embodiment, the aromatic diacid dichloride(s) may comprise aromatic diacid dichloride commonly used in the art disclosed herein. The aromatic diacid dichloride may be, for example, any one or more of isophthaloyl dichloride (IPC), terephthaloyl dichloride (TPC), 1,1′-biphenyl-4,4′-dicarbonyl dichloride (BPC),1,4-naphthalene dicarboxylic dichloride (NPC), 2,6-naphthalene dicarboxylic dichloride (NTC), 1,5-naphthalene dicarboxylic dichloride (NEC), and/or a derivative thereof.

In one embodiment, the polyamideimide film may further comprise, but is not limited to, units derived from other known dianhydrides, diamines, and dichlorides.

In one embodiment, the aromatic diacid dichloride(s) (or units derived from the aromatic diacid dichloride) may be comprised in an amount of more than 40 mol % and 90 mol % or less, 50 mol % to mol %, 55 mol % to 80 mol %, 60 mol % to 80 mol %, 65 mol % to 75 mol %, or about 70 mol % of the number of moles of the aromatic diamine (or units derived from the aromatic diamine).

Further, in one embodiment, the dianhydride(s) (or units derived from the dianhydride) may be comprised in an amount of 5 mol % to 50 mol %, 10 mol % to 50 mol %, 20 mol % to 50 mol %, 20 mol % to 40 mol %, 25 mol % to 35 mol %, or about 30 mol % of the number of moles of the aromatic diamine (or units derived from the aromatic diamine).

The polyamideimide film according to some embodiments has ultraviolet (UV) weather resistance, and in some embodiments, may have a rate of change in color difference (ΔE) value of 6.0 or less, 5.5 or less, or 5.4 or less, 5.0 or less, 4.5 or less, 4.0 or less, 3.5 or less, or 3.0 or less on day 4 (n=4) of ultraviolet irradiation according to the following Equation 1. The lower limit of the rate of change in color difference may be, for example, 1.0 or more, 1.5 or more, 2.0 or more, or 2.5 or more.

Also, the polyamideimide film according to some embodiments may have weather resistance when irradiated with ultraviolet light for a long time. In some embodiments, the polyamideimide film according to one embodiment may have a rate of change in color difference (ΔE) value of 8.0 or less, 7.0 or less, 6.5 or less, or 6.0 or less on day 24 (n=24) of ultraviolet irradiation according to the following Equation 1:

ΔE={(L*₀-L*ₙ)²+(a*₀−a*ₙ)²+(b*₀−b*ₙ)²}^{1/2} [Equation 1]
wherein L*₀ is a lightness index of the polyamideimide film before UV irradiation,
L*ₙ is a lightness index of the polyamideimide film on day n of ultraviolet irradiation,
a*₀ and b*₀ are color coordinates of the polyamideimide film before UV irradiation, and
a*ₙ and b*ₙ are color coordinates of the polyamideimide film on day n of ultraviolet irradiation.

The optical multilayer structure according to some embodiments may have an a*₀ value of, for example, −2.0 to −0.1, −1.5 to −0.1, −1.5 to −0.2, −1.2 to −0.2, or −1.2 to −0.3. A b*₀ value may be, for example, 0.3 to 2.0, 0.5 to 2.0, or 0.6 to 1.9. When n=4, the optical multilayer structure according to some embodiments may have a*₄ value of, for example, −3.0 to −1.0, −2.5 to −1.0, or −2.3 to −1.0. A b*₄ value when n=4 may be, for example, 2.0 to 8.0, 2.0 to 7.0, 2.8 to 7.0, or 2.8 to 6.8. When n=24, the optical multilayer structure according to one embodiment may have an a*₂₄ value of, for example, −3.0 to −1.0 or −2.5 to −1.0. A b*₂₄ value for n=24 may be, for example, 3.0 to 8.0, 4.0 to 7.0, or 4.0 to 6.0.

The lightness index (L) and the color coordinates (a, b) mean values of coordinate axes representing unique colors, respectively. Specifically, L has a value of 0 to 100, wherein the closer to 0 the polyamideimide film exhibits a black color, and the closer to 100 the polyamideimide film exhibits a white color. a has positive (+) and negative (−) values based on 0, wherein a positive number (+) means that the polyamideimide film exhibits a red color, and a negative number (−) means that the polyamideimide film exhibits a green color. b has positive (+) and negative (−) values based on 0, wherein a positive number (+) means that the polyamideimide film exhibits a yellow color, and a negative number (−) means that the polyamideimide film exhibits a blue color.

The polyamideimide film according to some embodiments may use the polyamideimide film according to some embodiments in combination with the benzotriazole-based UV blocker to improve UV weather resistance, and/or remarkably suppress an increase in the rate of change in color difference, especially when exposed to ultraviolet rays for a long time and/or when exposed to a high amount of light.

The UV blocker(s) comprised in the polyamideimide film according to one embodiment may be comprised in an amount of 0.5% to 20% by weight based on the weight of the polyamideimide resin (or the weight of the solid content of the polyamideimide resin solution, or the total weight of monomers). The content of the UV blocker is not necessarily limited to the above range, and may also be, for example, 0.5% to 15% by weight, 1.0% to 15% by weight, 1.0% to 12% by weight, 1.5% to 10% by weight, 3.0% to 15% by weight, 3.0% to 12% by weight, 4.5% to 12% by weight, 4.5% to 10% by weight, 5% to 12% by weight, or 5% to 10% by weight.

The polyamideimide film according to one embodiment may further comprise additional additives as needed, in addition to the components described above. The additional additives may be for improving film formation, adhesion, optical properties, mechanical properties, and/or flame resistance, etc., and may be, for example, but not limited to, flame retardant(s), adhesion enhancer(s), inorganic particles, antioxidant(s), UV inhibitor(s), and/or plasticizer. Each of the additional additive(s) may be present in an amount of 0.1 to 20 weight percent, 0.1 to 15 weight percent, 0.1 to 10 weight percent, or 0.1 to 10 weight percent, based on the solid content of the polyamideimide resin solution.

The polyamideimide film according to one embodiment may have an initial yellow index (or a yellow index before UV irradiation) of 3.0 or less, 2.8 or less, 2.4 or less, 2.3 or less, 2.0 or less, 1.8 or less, 1.6 or less, or 1.5 or less. The lower limit of the yellow index may be, for example, 0.1 or more, 0.3 or more, 0.5 or more, 0.8 or more, or 1.0 or more. The yellow index may be measured according to ASTM E313 standard.

When the polyamideimide film according to one embodiment is irradiated with ultraviolet light for about 96 hours (n=4), the film may have a yellow index of 6.0 or less, 5.8 or less, 5.5 or less, 5.0 or less, 4.5 or less, 4.0 or less, 3.5 or less, or 3.0 or less. The lower limit of the yellow index may be, for example, or more, 0.3 or more, 0.5 or more, 0.8 or more, 1.0 or more, 1.5 or more, or 2.0 or more. The yellow index may be measured according to ASTM E313 standard.

The polyamideimide film according to one embodiment may have an initial modulus (or modulus before UV irradiation) of 6.0 GPa or more, 6.5 GPa or more, 7.0 GPa or more, 7.2 GPa or more, 7.3 GPa or more, 7.4 GPa or more, or 7.5 GPa or more. The upper limit of the modulus may be, for example, 10.0 GPa or less, 9.0 GPa or less, or 8.0 GPa or less. The modulus may be measured according to ASTM D882.

The polyamideimide film according to one embodiment may have an initial haze (or haze before UV irradiation) of 1.0% or less, or less, 0.9% or less, 0.8% or less, 0.78% or less, or 0.77% or less. The lower limit of the haze may be, for example, more than 0%, 0.1% or more, 0.2% or more, 0.3% or more, 0.4% or more, or 0.5% or more. The haze may be measured according to ASTM D1003.

Other embodiments provide an optical multilayer structure comprising a polyamideimide film comprising a polyamideimide resin(s) and a benzotriazole-based UV blocker(s) as disclosed herein, and one or more hard coating layer(s) formed on the polyamideimide film.

In one embodiment, the hard coating layer(s) may be formed on either or both sides of the polyamideimide film.

In some embodiments, the hard coating layer(s) may comprise a UV blocker(s) comprising a benzotriazole-based compound(s). The benzotriazole-based compound(s) is not particularly limited as long as it is benzotriazole (C₆H₅N₃) or a derivative thereof. In some embodiments, the benzotriazole-based compound(s) may comprise any one or more of the following compounds A to F:

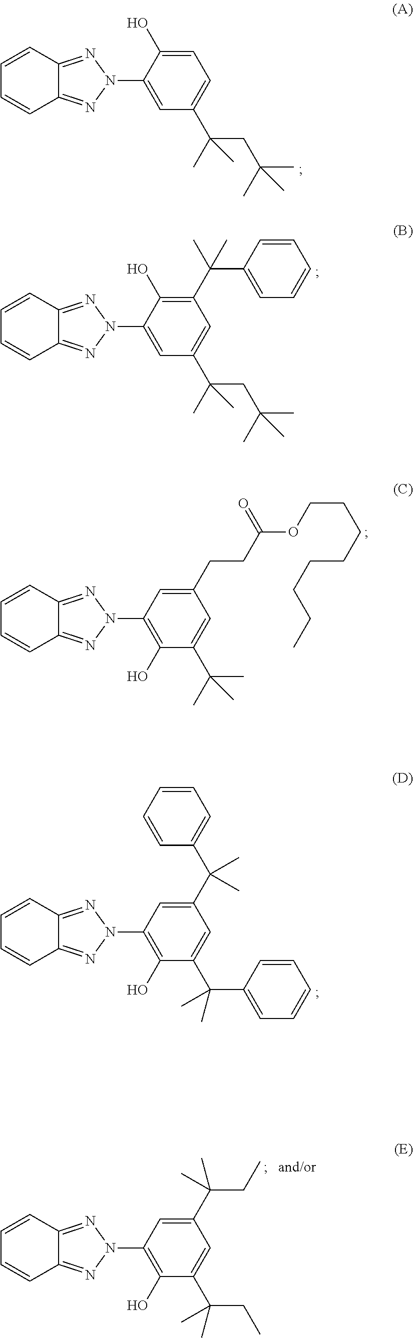 [SMILES: CC(C)(C)CC(C)(C)c1ccc(O)c(-n2nc3ccccc3n2)c1 ; CC(C)(C)CC(C)(C)c1cc(-n2nc3ccccc3n2)c(O)c(C(C)(C)c2ccccc2)c1 ; CCCCCCCCOC(=O)CCc1cc(-n2nc3ccccc3n2)c(O)c(C(C)(C)C)c1 ; CC(C)(c1ccccc1)c1cc(-n2nc3ccccc3n2)c(O)c(C(C)(C)c2ccccc2)c1 ; CCC(C)(C)c1cc(-n2nc3ccccc3n2)c(O)c(C(C)(C)CC)c1]

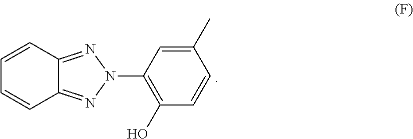 [SMILES: Cc1ccc(O)c(-n2nc3ccccc3n2)c1]

The benzotriazole-based compound according to some embodiments may comprise any one or more of the following compounds A to C. In some embodiments, the benzotriazole-based compound may be any one or more of the following compounds A to compounds C:

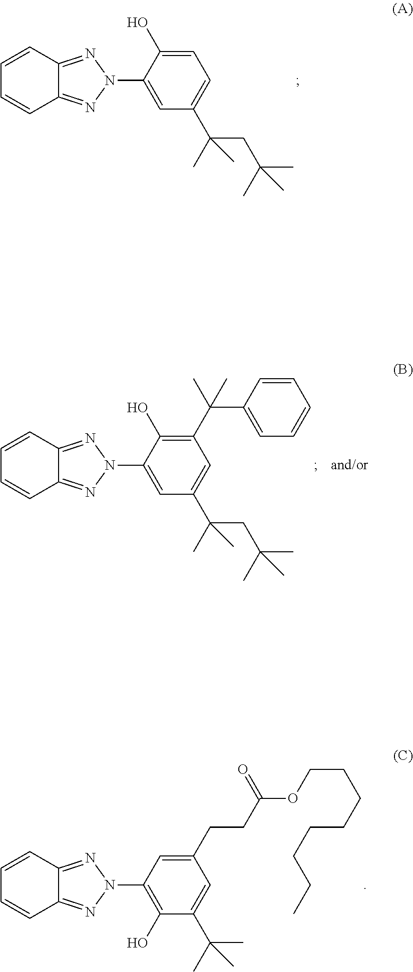 [SMILES: CC(C)(C)CC(C)(C)c1ccc(O)c(-n2nc3ccccc3n2)c1 ; CC(C)(C)CC(C)(C)c1cc(-n2nc3ccccc3n2)c(O)c(C(C)(C)c2ccccc2)c1 ; CCCCCCCCOC(=O)CCc1cc(-n2nc3ccccc3n2)c(O)c(C(C)(C)C)c1]

The UV blocker(s) comprised in the hard coating layer according to one embodiment may be comprised in an amount of 0.5% to 10% by weight, 1% to 10% by weight, 1% to 8% by weight, 1% to 6% by weight, 1% to 5% by weight, 2% to 8% by weight, 2% to 6% by weight, 2% to 5% by weight, or about 3% by weight based on the weight of the solid content of the composition for forming the hard coating layer.

The benzotriazole-based compound(s) comprised in the hard coating layer according to one embodiment may be chemically the same as or different from the benzotriazole-based compound comprised in the polyamideimide film. The optical multilayer structure according to one embodiment may further increase UV weather resistance by comprising the UV blocker in both the polyamideimide film and the hard coating layer. However, this is only one example that can achieve the desired effect in one embodiment, and one embodiment to be provided in the specification is not necessarily limited to an optical multilayer structure in which both the polyamideimide film and the hard coating layer comprise the UV blocker.

In some embodiments, the polyamideimide film may have a thickness of 1 μm to 500 μm, 10 μm to 250 μm, 10 μm to 100 μm, or μm to 100 μm, or 20 μm to 80 μm, 30 μm to 80 μm, 40 μm to 60 μm, or about 50 μm, but is not necessarily limited to the above thickness range.

In some embodiments, the hard coating layer may have a thickness of 1 μm to 100 μm, 1 μm to 50 μm, 5 μm to 50 μm, 1 μm to μm, 1 μm to 30 μm, 1 μm to 20 μm, 5 μm to 15 μm, or about 10 μm, but is not necessarily limited to the above thickness range.

The hard coating layer according to an embodiment may be formed from a composition for forming a hard coating layer comprising an epoxysilane resin(s). For example, the composition for forming the hard coating layer may comprise or be made of an epoxy silane resin(s) (30 to 40 parts by weight), an initiator (1 part by weight of photoinitiator/thermal initiator), an epoxy monomer(s) (5 to 10 parts by weight), an additive(s) (1 to 2 parts by weight), a solvent(s) (40 to 60 parts by weight), and the like.

In some embodiments, the hard coating layer(s) may comprise an epoxysilane resin(s). For example, the hard coating layer may be formed from a composition for forming a hard coating layer comprising an epoxy siloxane resin(s). For example, the epoxy siloxane resin may be a siloxane resin(s) containing an epoxy group. The epoxy group may be a cyclic epoxy group, an aliphatic epoxy group, an aromatic epoxy group, or combination thereof. The siloxane resin may refer to a polymer compound in which a silicon atom and an oxygen atom are covalently bonded.

The epoxy siloxane resin may be, for example, a silsesquioxane resin. The silsesquioxane resin may be, for example, a compound in which a silicon atom of the silsesquioxane compound is directly substituted with an epoxy group or a substituent substituted with the silicon atom is substituted with an epoxy group. A non-limiting example thereof may comprise a silsesquioxane resin substituted with a 2-(3,4-epoxycyclohexyl) group or a 3-glycidoxy group.

According to some embodiments, the epoxy siloxane resin(s) may have a weight average molecular weight of 1,000 g/mol to 20,000 g/mol. When the weight average molecular weight is within the range as described above, the composition for forming a hard coating layer may have an appropriate viscosity, and thus may have improved flowability, coatability, curing reactivity, and/or hardness of the hard coating layer.

In one embodiment, the epoxy siloxane resin(s) may be prepared by a hydrolysis and condensation of an alkoxy silane comprising an epoxy group alone or between an alkoxy silane comprising an epoxy group and a heterogeneous alkoxy silane in the presence of water. Also, the epoxysiloxane resin may be formed by polymerizing a silane compound comprising an epoxycyclohexyl group.

The alkoxysilane compound(s) comprising the epoxy group may comprise, for example, 2-(3,4-epoxycyclohexyl)ethyltrimethoxysilane, 2-(3,4-epoxycyclohexyl)ethyltriethoxysilane, and/or 3-glycidoxypropyltrimethoxysilane, etc. These polymers may be used alone or in combination of two or more.

In one embodiment, the epoxy siloxane resin(s) may be comprised in an amount of 20 parts by weight to 70 parts by weight, or 20 parts by weight to 50 parts by weight based on 100 parts by weight of the composition for forming a hard coating layer. If the amount of the epoxy siloxane resin(s) is less than the above content, the viscosity of the composition for forming the hard coating layer is excessively decreased, making it difficult to control a thickness of the coating layer and a hardness of the coating layer may be decreased. If the amount of the epoxy siloxane resin exceeds the above content, the viscosity of the composition for forming a coating layer may be excessively increased, resulting in a decreasing in flowability and coatability, disadvantageous thin film formation. Also, the time required for complete curing may be increased, such that curing may occur unevenly during curing, and physical defects such as cracks may occur due to partial overcuring.

In some embodiments, the composition for forming a coating layer may comprise a crosslinking agent(s). The crosslinking agent(s) may, for example, form a crosslinking bond with an epoxy siloxane resin to solidify the composition for forming a coating layer and improve the hardness of the coating layer.

In one embodiment, the crosslinking agent may comprise a compound in which two 3,4-epoxycyclohexyl groups are connected. The content of the crosslinking agent is not particularly limited, and may be comprised in an amount of, for example, 5 parts by weight to 150 parts by weight, 3 parts by weight to 30 parts by weight, or 5 parts by weight to 20 parts by weight based on 100 parts by weight of the epoxy siloxane resin. If the content of the crosslinking agent is within the above range, the viscosity of the composition may be maintained within an appropriate range, and coatability and curing reactivity may be improved.

In one embodiment, the composition for forming a hard coating layer may comprise a photoinitiator(s) or a thermal initiator(s).

The photoinitiator(s) may comprise a photo-cationic initiator(s). The photocationic initiator(s) may initiate polymerization of the epoxy siloxane resin and a epoxy-based monomer. As the photocationic initiator(s), for example, an onium salt and/or an organometallic salt may be used, but is not limited thereto. For example, diaryliodonium salts, triarylsulfonium salts, aryldiazonium salts, iron-arene complexes, and/or the like may be used. These may be used alone or in combination of two or more.

The content of the photoinitiator(s) is not particularly limited, and may be comprised in an amount of, for example, 1 part by weight to 15 parts by weight, 0.1 part by weight to 10 parts by weight, or 0.3 parts by weight to 5 parts by weight based on 100 parts by weight of the epoxy siloxane resin. If the content of the photoinitiator is within the above range, the curing efficiency of the composition may be excellently maintained, and deterioration in physical properties due to residual components after curing may be prevented.

In one embodiment, the composition for forming a hard coating layer may further comprise a solvent(s). The solvent(s) is not particularly limited, and solvents known in the art may be used. Non-limiting examples of the solvent may comprise alcohol-based (methanol, ethanol, isopropanol, butanol, methyl cellosolve, ethyl cellosolve, etc.), ketone-based (methyl ethyl ketone, methyl butyl ketone, methyl isobutyl ketone, diethyl ketone, dipropyl ketone, cyclohexanone, etc.), hexane-based (hexane, heptane, octane, etc.), and/or benzene-based (benzene, toluene, xylene, etc.) solvents. These may be used alone or in combination of two or more. In one embodiment, the solvent may be comprised in a residual amount excluding the amount occupied by the remaining components from the total weight of the composition.

In one embodiment, the composition for forming a hard coating layer may further comprise additive(s) such as an inorganic filler(s), a lubricant(s), an antioxidant(s), a UV absorber(s), a light stabilizer(s), a thermal polymerization inhibitor(s), a leveling agent(s), a surfactant(s), a lubricant(s), and an antifouling agent(s). The inorganic filler may improve the hardness of the hard coating layer.

In one embodiment, the hard coating layer may be formed by applying a composition for forming a hard coating layer on a polyamideimide film and then performing a curing process by thermal curing and/or photocuring. For example, after drying at about 50° C. to 120° C., 60° C. to 120° C., 60° C. to 110° C., 70° C. to 110° C., 70° C. to 100° C., ° C. to 90° C., or about 80° C. for 1 min to 10 min, 1 min to 8 min, 1 min to 5 min, or about 3 min, photocuring may be performed with ultraviolet light of about 1,000 J/cm² to about 2,000 J/cm². Also, if necessary, additional heat treatment (heat curing) may be performed at 100° C. to 200° C., 120° C. to 180° C., 130° C. to 170° C., 140° C. to 160° C., or about 150° C., for example, 1 min to 30 min, 5 min to 30 min, 5 min to 20 min, 5 min to 15 min, or about 10 min.

Another embodiment provides a method for manufacturing a polyamideimide film according to the above embodiment.

In one embodiment, the method for manufacturing a polyamideimide film may comprise: preparing a polyamide-imide resin solution; and applying, drying, heat-treating, and/or stretching the polyamideimide resin solution (film formation step), wherein the UV blocker(s) comprising the benzotriazole-based compound(s) may be added to the polyamideimide resin solution immediately before film formation of the polyamideimide film (for example, immediately before heat treatment), or may be added in the preparation of the polyamideimide resin solution.

The polyamideimide resin solution according to the embodiment may be prepared by adding all monomers comprising dianhydride, diamine and diacid dichloride, followed by precipitation, or may also be prepared by mixing the diamine and the diacid dichloride to precipitate first and then mixing the remaining monomers.

In some embodiments, the polyamideimide resin solution according may be prepared by imidizing a polyamideimide precursor and/or polyamideimide and a solvent. The imidization may be performed through chemical imidization using any one or two or more selected from an imidization catalyst and a dehydrating agent. As the imidization catalyst, any one or two or more selected from pyridine, isoquinoline, and/or β-quinoline may be used. Also, as the dehydrating agent, any one or two or more selected from the group consisting of acetic anhydride, phthalic anhydride, and/or maleic anhydride may be used. However, the imidization catalyst and the dehydrating agent may be used by selecting commonly used ones, and are not necessarily limited to the above types.

In one embodiment, the solid content of the polyamideimide precursor and/or the polyamideimide solution may be, for example, 5% to 40% by weight, 5% to 35% by weight, 10% to 35% by weight, 10% to 30% by weight, 10% to 20% by weight, or about 15% by weight based on the total weight of the solution.

In one embodiment, after the imidization, the resin is purified using a solvent to obtain a solid, and the solid is dissolved in a solvent to obtain a solution, and then a film may be formed using the solution.

In the manufacture of the polyamideimide film, an organic solvent commonly used in the technical field disclosed herein may be used. For example, any one or two or more solvents selected from the group consisting of dimethylacetamide (DMAc), N-methyl-2-pyrrolidone (NMP), dimethylformamide (DMF), dimethylformamide (DMSO), ethyl cellosolve, methyl cellosolve, acetone, ethylacetate, m-cresol, gamma butyrolactone (GBL) and/or derivatives thereof may be used.

In one embodiment, the drying and/or heat treatment may be performed in stages. For example, it may be subjected to heat treatment in stages by performing primary drying at 70° C. to 160° C. for 1 min to 2 hrs, and secondary drying at 150° C. to 450° C. for 1 min to 2 hrs. However, drying is not necessarily limited to the above temperature and time conditions. For example, the primary drying may be performed at 25° C. to 220° C., 80° C. to 150° C., 70° C. to 110° C., 80° C. to 100° C., or about 90° C. for 1 min to 300 min, 10 min to 150 min, 10 min to 90 min, 20 min to 60 min, or about 30 min, and the secondary drying may be performed at 200° C. to 500° C., 200° C. to 400° C., 250° C. to 350° C., or about 300° C. for 1 min to 300 min, 10 min to 150 min, 10 min to 90 min, 20 min to 60 min, or for about 30 min. Here, the temperature may be raised in the range of 1 to ° C./min during each step movement in the heat treatment in stages. Also, the heat treatment may be performed in a separate vacuum oven or an oven filled with an inert gas. However, it is not necessarily limited thereto. Also, the coating may be formed into a film on a support using an applicator.

Another embodiment provides a display device comprising the polyamideimide film or the optical multilayer structure according to the embodiment. Various types of molded articles may be manufactured using a polyamideimide film or an optical multilayer structure according to the embodiment, and may be applied to, for example, a printed wiring board comprising a protective film or an insulating film, a flexible circuit board, a cover window for a display, or a protective film for a display, etc.

The display device may be various image display devices such as a conventional liquid crystal display device, an electroluminescent display device, a plasma display device, or a field emission display device. The polyamideimide film and/or the optical multilayer structure according to one embodiment may have good display quality and UV weather resistance, so visibility and durability may be excellent.

Hereinafter, Examples and Experimental Examples will be specifically illustrated and described. However, the following Examples and Experimental Examples are merely illustrative of a part of one embodiment, and the technology described herein is not limited thereto.

UV Blocker

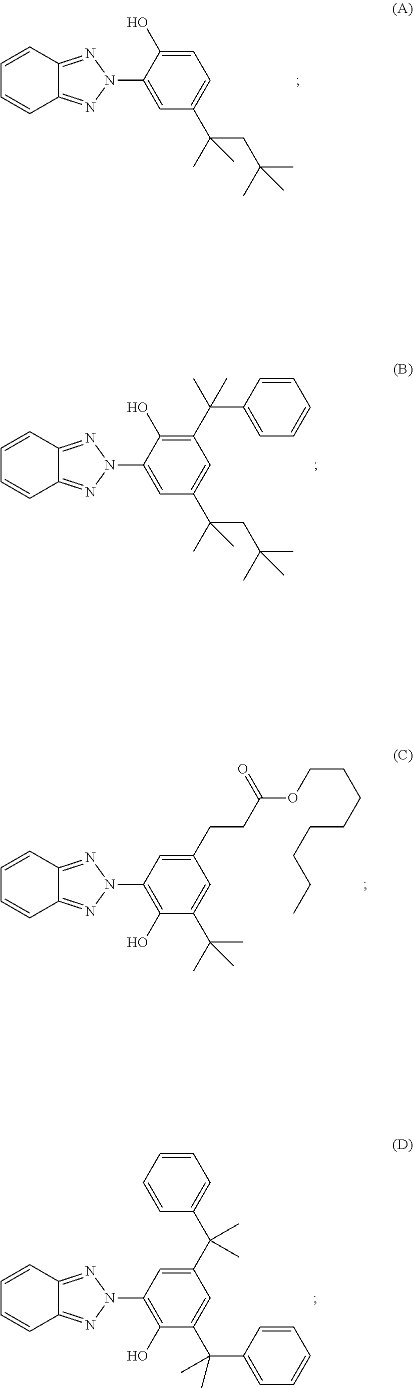 [SMILES: CC(C)(C)CC(C)(C)c1ccc(O)c(-n2nc3ccccc3n2)c1 ; CC(C)(C)CC(C)(C)c1cc(-n2nc3ccccc3n2)c(O)c(C(C)(C)c2ccccc2)c1 ; CCCCCCCCOC(=O)CCc1cc(-n2nc3ccccc3n2)c(O)c(C(C)(C)C)c1 ; CC(C)(c1ccccc1)c1cc(-n2nc3ccccc3n2)c(O)c(C(C)(C)c2ccccc2)c1]

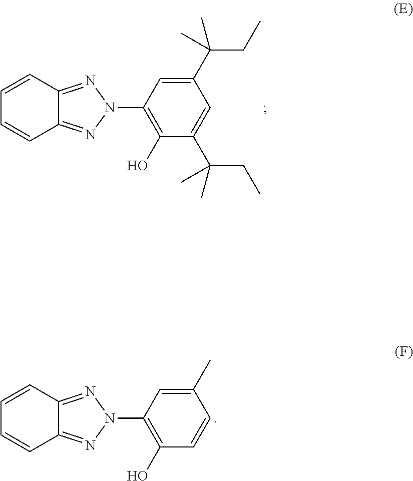 [SMILES: CCC(C)(C)c1cc(-n2nc3ccccc3n2)c(O)c(C(C)(C)CC)c1 ; Cc1ccc(O)c(-n2nc3ccccc3n2)c1]

### Example 1-1 to Example 3-4

### Step 1: Manufacture of Polyamideimide Film

Terephthaloyl dichloride (TPC) and 2,2′-bis(trifluoromethyl)-benzidine (TFMB) in a mixed solution of dichloromethane and pyridine were added to a reactor, and stirred at 25° C. for 2 hours under a nitrogen atmosphere. Here, a molar ratio of TPC:TFMB was set to 300:400, and the solid content was adjusted to be 10% by weight. Thereafter, the reactant was precipitated in an excess of methanol, and then the solid content obtained by filtration was dried under vacuum at 50° C. for 6 hours or more to obtain an oligomer. The prepared oligomer had a formula weight (FW) of 1670 g/mol.

A solvent N,N-dimethylacetamide (DMAc), 100 mol of the oligomer, and 28.6 mol of TFMB were added to the reactor, and sufficiently stirred. After confirming that the solid raw material was completely dissolved, a fumed silica (surface area 95 m²/g, <1 μm) was added to DMAc in an amount of 1000 ppm relative to the solid content, and dispersed and added using ultrasonic waves. 64.1 mol of 1,2,3,4-cyclobutane tetracarboxylic dianhydride (CBDA) and 64.1 mol of 4,4′-hexafluoroisopropylidene diphthalic dianhydride (6FDA) were sequentially added and sufficiently stirred, followed by polymerization at 40° C. for 10 hours. Here, the solid content was 15% by weight. Then, pyridine and acetic anhydride were sequentially added to the solution in a molar amount of 2.5 times the total amount of dianhydride, respectively, and stirred at 60° C. for 12 hours to prepare a polyimide-based resin solution.

Meanwhile, a solvent N,N-dimethylacetamide and 10% by weight of a UV blocker according to Table 1 were added to a separate reactor and sufficiently stirred at room temperature to prepare a UV blocker solution. Then, the UV blocker solution was added to the polyimide-based resin solution so that the weight (content) of the UV blocker with respect to the weight of the solid content was as shown in Table 1 below, and stirred at 40° C. for 2 hours to prepare a polyimide-based resin solution containing the UV blocker.

Solution casting of the polyimide-based resin solution containing the UV blocker was performed on a glass substrate using an applicator. Thereafter, after drying in a drying oven at 90° C. for 30 minutes, the temperature was raised to 300° C. for 30 min, heat treatment was performed at that temperature for 30 min, and then the film formed on the glass substrate was separated from the substrate to obtain a polyamideimide film having a thickness of about 50 μm.

### Step 2: Manufacture of Hard Coating Layer

When a composition for forming a hard coating layer was prepared, a brown container was used to suppress the reaction by ultraviolet light. In addition, since the composition for forming a hard coating layer may cause aggregation or haze when added at once, each solution was prepared and then mixed, and solid and high-viscosity raw materials were first prepared and added thereto.

First, 1 kg of methyl ethyl ketone (MEK) was added to a 2 kg glass bottle, and 0.2 kg of (3′,4′-epoxycyclohexyl)methyl 3,4-epoxycyclohexanecarboxylate was added thereto as a crosslinking agent at 300 rpm. After stirring at 300 rpm for more than 5 min, the mixture was placed in a 2 kg brown bottle (Sub1). 1 kg of MEK was added to another 2 kg glass bottle, and 0.1 kg of (4-methylphenyl)[4-(2-methylpropyl)phenyl]iodonium hexafluorophosphate was added thereto as a photoinitiator. After stirring at 300 rpm for 5 min, the mixture was places in a 2 kg brown bottle (Sub2). A 2-ton reactor was prepared, 20 kg of solvent (MEK) and 10 kg of epoxy cyclohexyl carbonate, which is an epoxy monomer, were added thereto, stirred at 50 rpm for 5 min. Thereafter, 60 kg of silsesquioxane was added as an epoxy siloxane resin was added thereto and stirred at 50 rpm for 5 min. Then, the prepared Sub1 and Sub2 solutions were sequentially added thereto, and then stirred at 50 rpm for 30 min at a reactor internal temperature of 25±2° C. to prepare a composition for forming a hard coating layer.

The prepared composition for forming a hard coating layer was applied to one surface of the polyamideimide film and dried in an oven at 80° C. for 3 minutes. After photocuring by irradiating ultraviolet light at 1,000 J/cm² to 2,000 J/cm² using a metal halide high-pressure metal lamp, a hard coating layer having a thickness of about 10 μm was manufactured by thermally curing in an oven at 150° C. for 10 min to manufacture an optical multilayer structure.

### Examples 4 to 6

Optical multilayer structures were manufactured in the same manner as in Examples 1-1 to 3-4, except that the UV blocker was used in the type and amount shown in Table 1 below.

### Example 7

An optical multilayer structure was manufactured in the same manner as in Example 1-1, except that in the manufacturing of the hard coating layer, the optical multilayer structure comprising the UV blocker in a polyamideimide film and a hard coating layer was manufactured by adding 1 kg of MEK to a 5 kg glass bottle, adding 3% by weight of UV blocker C based on the weight of the solid content of the composition for forming a hard coating layer, and stirring it at 300 rpm to prepare Sub3 in a brown bottle and sequentially adding the mixture together with Sub1 and Sub2 solutions.

### Comparative Example 1

An optical multilayer structure was manufactured in the same manner as in Examples 1-1 to 3-4, except that the optical multilayer structure was manufactured without using the UV blocker in the manufacturing of the polyamideimide film.

### Comparative Example 2

The optical multilayer structure was manufactured in the same manner as in Example 7, except that the optical multilayer structure was manufactured without using the UV blocker in the manufacturing of the polyamideimide film.

### Experimental Example

(1) Total Transmittance (T.T)

Total transmittance measured in the entire wavelength range of 400 nm to 700 nm was measured using a spectrophotometer (Nippon Denshoku, COH-400) according to ASTM D1003 standard. The unit of the total transmittance is %.

(2) Haze

Haze was measured using a spectrophotometer (Nippon Denshoku, COH-400) according to ASTM E313 standard. The unit of haze is %.

(3) Yellow Index (YI)

A yellow index was measured using a colorimeter (Hunter Associates Laboratory, Inc., ColorQuest XE) according to ASTM E313 standard.

(4) Transmittance (T)

Single wavelength transmittance measured at 380 nm and 388 nm was measured using UV/Vis (Shimadzu, UV3600) according to ASTM D1746 standard. The unit of the transmittance is %.

(5) Modulus

Modulus was measured using an UTM 3365 (Instron Corporation) under conditions of pulling the optical multilayer structure having a thickness of 50 μm, a length of 50 mm, and a width of 10 mm at 50 mm/min at 25° C. according to ASTM D882 standard. The unit of the modulus is GPa.

The mechanical and optical properties of the optical multilayer structures according to Examples and Comparative Examples were measured by the above method, and the results are shown in Table 1 below.

TABLE 1

| | Type, | | | | | | |
|---|---|---|---|---|---|---|---|
| | content of | | | | T | T | |
| | UV blocker | T · T | Haze | | (%, | (%, | Modulus |
| | (wt %) | (%) | (%) | YI | 380 nm) | 388 nm) | (GPa) |
| Example | A, | 90.18 | 0.62 | 0.98 | 18.21 | 44.97 | 7.39 |
| 1-1 | 1.5 wt % | | | | | | |
| Example | A, | 90.17 | 0.77 | 1.09 | 9.69 | 35.28 | 7.50 |
| 1-2 | 3.0 wt % | | | | | | |
| Example | A, | 90.15 | 0.78 | 1.20 | 3.38 | 22.74 | 7.60 |
| 1-3 | 5.0 wt % | | | | | | |
| Example | A, | 90.15 | 0.81 | 1.29 | 0.85 | 12.63 | 7.73 |
| 1-4 | 7.0 wt % | | | | | | |
| Example | A, | 90.14 | 0.80 | 1.51 | 0.21 | 7.32 | 7.93 |
| 1-5 | 10.0 wt % | | | | | | |
| Example | B, | 90.23 | 0.57 | 1.21 | 11.08 | 29.99 | 7.31 |
| 2-1 | 1.5 wt % | | | | | | |
| Example | B, | 90.23 | 0.69 | 1.54 | 2.75 | 15.28 | 7.39 |
| 2-2 | 3.0 wt % | | | | | | |
| Example | B, | 90.17 | 0.69 | 1.96 | 0.17 | 4.06 | 7.55 |
| 2-3 | 5.0 wt % | | | | | | |
| Example | B, | 90.16 | 0.72 | 2.25 | 0.0 | 1.55 | 7.48 |
| 2-4 | 7.0 wt % | | | | | | |
| Example | B, | 90.17 | 0.74 | 2.71 | 0.0 | 0.41 | 7.39 |
| 2-5 | 10.0 wt % | | | | | | |
| Example | C, | 90.11 | 0.51 | 1.02 | 31.16 | 54.14 | 7.34 |
| 3-1 | 0.5 wt % | | | | | | |
| Example | C, | 90.10 | 0.56 | 1.18 | 13.37 | 36.31 | 7.46 |
| 3-2 | 1.5 wt % | | | | | | |
| Example | C, | 90.12 | 0.59 | 1.34 | 4.16 | 21.48 | 7.52 |
| 3-3 | 3.0 wt % | | | | | | |
| Example | C, | 90.11 | 0.52 | 1.45 | 1.54 | 12.93 | 7.62 |
| 3-4 | 5.0 wt % | | | | | | |
| Example 4 | D, | 90.21 | 0.41 | 2.29 | 8.72 | 29.99 | 7.53 |
| | 5.0 wt % | | | | | | |
| Example 5 | E, | 90.22 | 0.43 | 2.09 | 11.00 | 29.97 | 7.46 |
| | 5.0 wt % | | | | | | |
| Example 6 | F, | 90.18 | 0.45 | 2.28 | 14.86 | 42.62 | 7.48 |
| | 5.0 wt % | | | | | | |
| Comp. | — | 90.41 | 0.52 | 0.91 | 55.58 | 71.93 | 7.27 |
| Example 1 | | | | | | | |

Next, the lightness index (L*) and the color coordinates (a*, b*) of the optical multilayer structures according to Examples and Comparative Examples before and after UV irradiation were measured, and the results are shown in Tables 2 and 3 below. The lightness index and the color coordinates were measured using a colorimeter (Hunter Associates Laboratory, Inc., ColorQuest XE) according to ASTM E308 standard.

TABLE 2

| | Before UV irradiation | | | | After UV irradiation (n = 4) | | | | |
|---|---|---|---|---|---|---|---|---|---|
| | L*₀ | a*₀ | b*₀ | YI₀ | L*ₙ | a*ₙ | b*ₙ | YIₙ | ΔE |
| Example | 95.47 | −0.37 | 0.65 | 0.98 | 95.58 | −1.74 | 4.51 | 7.20 | 4.10 |
| 1-1 | | | | | | | | | |
| Example | 95.44 | −0.37 | 0.71 | 1.09 | 95.57 | −1.52 | 4.04 | 6.54 | 3.53 |
| 1-2 | | | | | | | | | |
| Example | 95.43 | −0.40 | 0.77 | 1.19 | 95.67 | −1.34 | 3.39 | 5.45 | 2.79 |
| 1-3 | | | | | | | | | |
| Example | 95.46 | −0.44 | 0.86 | 1.33 | 95.66 | −1.30 | 3.20 | 5.14 | 2.50 |
| 1-4 | | | | | | | | | |
| Example | 95.43 | −0.50 | 1.01 | 1.56 | 95.68 | −1.24 | 2.99 | 4.77 | 2.13 |
| 1-5 | | | | | | | | | |
| Example | 95.44 | −0.43 | 0.88 | 1.21 | 95.54 | −1.86 | 5.05 | 8.09 | 4.41 |
| 2-1 | | | | | | | | | |
| Example | 95.45 | −0.55 | 1.03 | 1.58 | 95.60 | −1.76 | 4.56 | 7.33 | 3.53 |
| 2-2 | | | | | | | | | |
| Example | 95.51 | −0.71 | 1.25 | 1.99 | 95.65 | −1.77 | 4.34 | 6.91 | 3.09 |
| 2-3 | | | | | | | | | |
| Example | 95.46 | −0.86 | 1.55 | 2.31 | 95.67 | −1.76 | 4.20 | 6.65 | 2.65 |
| 2-4 | | | | | | | | | |
| Example | 95.44 | −1.00 | 1.84 | 2.75 | 95.68 | −1.82 | 4.23 | 6.66 | 2.39 |
| 2-5 | | | | | | | | | |
| Example | 95.44 | −0.33 | 0.65 | 1.02 | 95.47 | −1.96 | 5.76 | 9.13 | 5.36 |
| 3-1 | | | | | | | | | |
| Example | 95.44 | −0.39 | 0.75 | 1.18 | 95.51 | −1.77 | 4.92 | 7.75 | 4.39 |
| 3-2 | | | | | | | | | |
| Example | 95.44 | −0.45 | 0.86 | 1.34 | 95.60 | −1.55 | 4.06 | 6.56 | 3.39 |
| 3-3 | | | | | | | | | |
| Example | 95.56 | −0.47 | 1.3 | 2.15 | 95.62 | −1.49 | 4.36 | 7.16 | 3.23 |
| 3-4 | | | | | | | | | |
| Example | 95.54 | −0.52 | 1.39 | 2.29 | 95.59 | −1.65 | 4.87 | 7.98 | 3.66 |
| 4 | | | | | | | | | |
| Example | 95.54 | −0.44 | 1.25 | 2.09 | 95.43 | −1.93 | 6.00 | 9.87 | 4.98 |
| 5 | | | | | | | | | |
| Example | 95.44 | −0.43 | 1.35 | 2.28 | 95.55 | −1.92 | 5.54 | 9.02 | 4.45 |
| 6 | | | | | | | | | |
| Comp. | 95.43 | −0.31 | 0.59 | 0.91 | 95.40 | −2.22 | 6.53 | 10.61 | 6.24 |
| Example 1 | | | | | | | | | |

TABLE 3

| | | | | | After UV irradiation | | | | |
|---|---|---|---|---|---|---|---|---|---|
| | Before UV irradiation | | | | (n = 24) | | | | |
| | L*₀ | a*₀ | b*₀ | YI₀ | L*ₙ | a*ₙ | b*ₙ | YIₙ | ΔE |
| Example | 95.43 | −0.40 | 0.77 | 1.19 | 95.65 | −2.03 | 5.67 | 9.18 | 5.17 |
| 1-3 | | | | | | | | | |
| Example | 95.51 | −0.71 | 1.25 | 1.99 | 95.47 | −2.07 | 6.42 | [symbol] 0.53 | 5.35 |
| 2-3 | | | | | | | | | |
| Example | 95.44 | −0.39 | 0.75 | 1.18 | 95.38 | −2.03 | 6.92 | [symbol] 1.23 | 6.36 |
| 3-2 | | | | | | | | | |
| Example | 95.54 | −0.52 | 1.39 | 2.29 | 95.47 | −2.52 | 7.89 | [symbol] 2.85 | 6.78 |
| 4 | | | | | | | | | |
| Example | 95.87 | −0.45 | 1.06 | 1.70 | 95.62 | −1.53 | 4.32 | 7.06 | 3.48 |
| 7 | | | | | | | | | |
| Comp. | 95.43 | −0.31 | 0.59 | 0.91 | 95.21 | −3.42 | 11.30 | [symbol] 8.20 | 11.09 |
| Example 1 | | | | | | | | | |

[symbol]

indicates data missing or illegible when filed

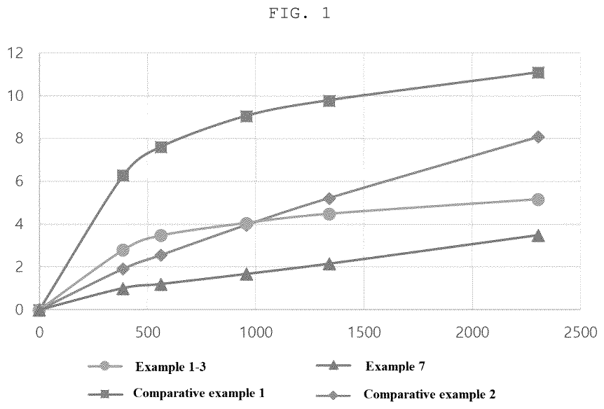

Next, a yellow index and a rate of change in color difference were observed while irradiating ultraviolet rays for a long time using the multilayer structures according to Examples 1-3, Example 7, Comparative Example 1, and Comparative Example 2. The results are shown in Table 4, Table 5, and FIG. 1 below.

TABLE 4

| | | Example | Example | Comp. | Comp. |
|---|---|---|---|---|---|
| | | 1-3 | 7 | Example 1 | Example 2 |
| Before | T (%, 388 | 22.74 | 15.94 | 71.93 | 48.16 |
| UV | nm) | | | | |
| irradiation | YI₀ | 1.20 | 1.70 | 0.91 | 1.48 |
| | Haze (%) | 0.78 | 0.68 | 0.52 | 0.32 |
| | L₀* | 95.43 | 95.87 | 95.43 | 96.00 |
| | a₀* | −0.40 | −0.45 | −0.31 | −0.26 |
| | b₀* | 0.77 | 1.06 | 0.59 | 0.87 |
| After | YIₙ | 5.45 | 3.32 | 10.61 | 4.51 |
| UV | L*ₙ | 95.67 | 95.76 | 95.40 | 95.82 |
| irridiation | a*ₙ | −1.34 | −0.74 | −2.22 | −0.84 |
| (n = 4) | b*ₙ | 3.39 | 2.02 | 6.53 | 2.68 |

| | | | | |
|---|---|---|---|---|
| ΔE | 2.79 | 1.01 | 6.24 | 1.91 |

TABLE 5

| UV | | | | | |
|---|---|---|---|---|---|
| irradiation | kJ/m² | Rate of change in color difference (ΔE) | | | |
| time | conversion | Example | Example | Comp. | Comp. |
| (h) | value ¹⁾ | 1-3 | 7 | Example 1 | Example 2 |
| 96 | 987.072 | 2.79 | 1.01 | 6.27 | 1.91 |
| 139 | 560.448 | 3.47 | 1.20 | 7.61 | 2.55 |
| 237 | 955.584 | 4.06 | 1.67 | 9.06 | 3.96 |
| 332 | 1338.624 | 4.49 | 2.15 | 9.79 | 5.22 |
| 571 | 2302.272 | 5.17 | 3.48 | 11.09 | 8.07 |

kJ/m² = amount of light (1.12 W/m²) × time (96 h × 3600 s/h)/1000

The optical multilayer structure comprising the UV blocker according to the above Examples had low haze and a yellow index and a high modulus, so that excellent optical and mechanical properties were simultaneously implemented, and UV weather resistance was excellent for a long time compared to the optical multilayer structures of the Comparative Examples. The optical multilayer structures according to the Examples were excellently suppressed from increasing the rate of change in color difference by ultraviolet light even when exposed to ultraviolet light for a long time, compared to the rapid increase in the rate of change in color difference as the time for irradiating the optical multilayer structures according to Comparative Examples with ultraviolet rays increases. In particular, Comparative Example 2 had a lower rate of change value in color difference than Examples 1-3 when exposed to ultraviolet light for about 237 hrs. However, afterwards, the rate of change value in color difference continuously increased significantly, and when exposed to ultraviolet rays for about 332 hrs or more, the rate of change value in color difference significantly increased compared to Examples 1-3.

The present disclosure relates to a polyamideimide film comprising a benzotriazole-based UV blocker, and an optical multilayer structure and a cover window for a display comprising the same. The polyamideimide film according to some embodiments has excellent UV weather resistance for a long time, low haze, a low yellow index, and/or high modulus, so that excellent optical and mechanical properties may be simultaneously implemented.

As described above, although some embodiments have been described in detail with reference to Examples and Experimental Examples, the scope of an embodiment is not limited to specific Examples and should be interpreted according to the accompanying claims.

1. A polyamideimide film comprising:
a polyamideimide resin comprising units derived from dianhydride, aromatic diamine, and aromatic diacid dichloride; and
a UV blocker comprising a benzotriazole-based compound.

2. The polyamideimide film of claim 1, wherein the benzotriazole-based compound comprises any one or more compounds selected from the group consisting of the following compounds: 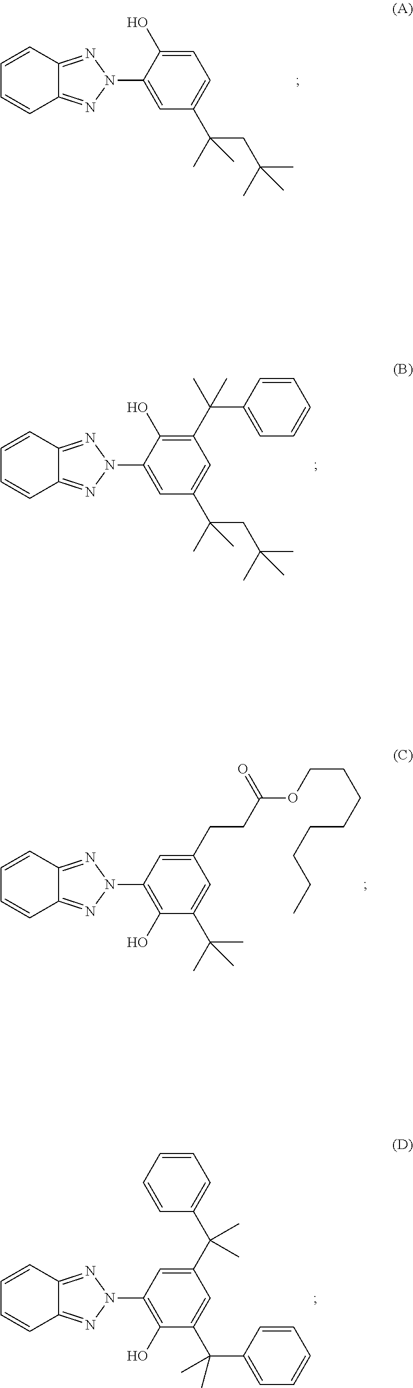 [SMILES: CC(C)(C)CC(C)(C)c1ccc(O)c(-n2nc3ccccc3n2)c1 ; CC(C)(C)CC(C)(C)c1cc(-n2nc3ccccc3n2)c(O)c(C(C)(C)c2ccccc2)c1 ; CCCCCCCCOC(=O)CCc1cc(-n2nc3ccccc3n2)c(O)c(C(C)(C)C)c1 ; CC(C)(c1ccccc1)c1cc(-n2nc3ccccc3n2)c(O)c(C(C)(C)c2ccccc2)c1] 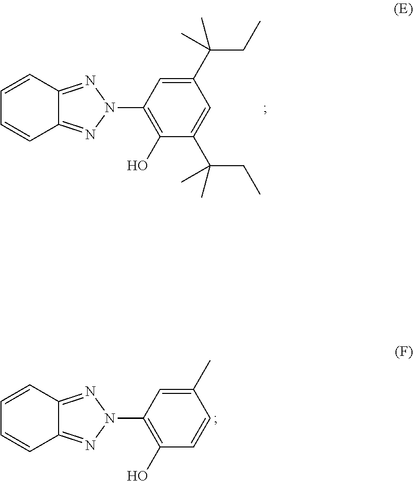 [SMILES: CCC(C)(C)c1cc(-n2nc3ccccc3n2)c(O)c(C(C)(C)CC)c1 ; Cc1ccc(O)c(-n2nc3ccccc3n2)c1]
and mixtures thereof.

3. The polyamideimide film of claim 1, wherein the benzotriazole-based compound is the following compound:

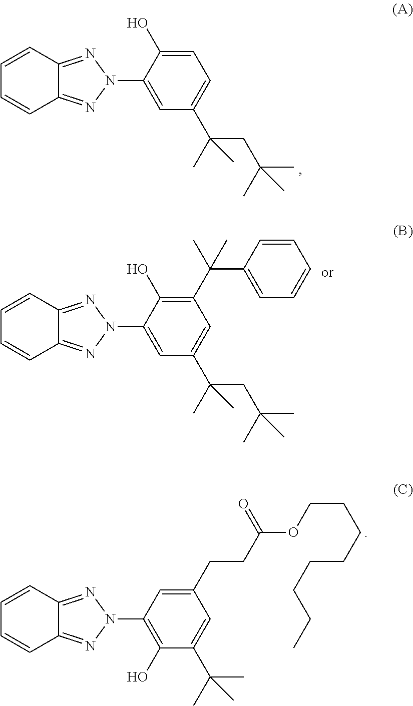 [SMILES: CC(C)(C)CC(C)(C)c1ccc(O)c(-n2nc3ccccc3n2)c1 ; CC(C)(C)CC(C)(C)c1cc(-n2nc3ccccc3n2)c(O)c(C(C)(C)c2ccccc2)c1 ; CCCCCCCCOC(=O)CCc1cc(-n2nc3ccccc3n2)c(O)c(C(C)(C)C)c1]

4. The polyamideimide film of claim 1, wherein the aromatic diamine comprises a fluorine-based aromatic diamine.

5. The polyamideimide film of claim 4, wherein the fluorine-based aromatic diamine is any one or more selected from the group consisting of 2,2′-bis(trifluoromethyl)benzidine (TFMB), 2,2-bis[4-(4-aminophenoxy)phenyl]hexafluoropropane (HFBAPP), 2,2-bis(4-aminophenyl)hexafluoropropane (BAHF), 2,2′-bis(trifluoromethyl)-4,4′-diaminodiphenylether, 4,4′-bis(4-amino-2-trifluoromethylphenoxy)biphenyl, 1,4-bis(4-amino-2-trifluoromethylphenoxy)benzene and mixtures thereof.

6. The polyamideimide film of claim 1, wherein the dianhydride comprises an aromatic dianhydride and/or a cycloaliphatic dianhydride.

7. The polyamideimide film of claim 1, wherein the units derived from the aromatic diacid dichloride are comprised in an amount of more than 50 mol % and 80 mol % or less based on the number of moles of the unit derived from the aromatic diamine.

8. The polyamideimide film of claim 1, wherein a rate of change in color difference (ΔE) value on day 4 (n=4) of ultraviolet irradiation according to the following Equation 1 is 6.0 or less:
ΔE={(L*₀−L*ₙ)²+(a*₀−a*ₙ)²+(b*₀−b*ₙ)²}^{1/2}
wherein L*₀ is a lightness index of the polyamideimide film before UV irradiation,
L*ₙ is a lightness index of the polyamideimide film on day n of ultraviolet irradiation,
a*₀ and b*₀ are color coordinates of the polyamideimide film before UV irradiation, and
a*ₙ and b*ₙ are color coordinates of the polyamideimide film on day n of ultraviolet irradiation.

9. The polyamideimide film of claim 1, wherein a rate of change in color difference (ΔE) value on day 24 (n=24) of ultraviolet irradiation according to the following Equation 1 is 8.0 or less:
ΔE={(L*₀−L*ₙ)²+(a*₀−a*ₙ)²+(b*₀−b*ₙ)₂}^{1/2} [Equation 1]
wherein L*₀ is a lightness index of the polyamideimide film before UV irradiation,
L*ₙ is a lightness index of the polyamideimide film on day n of ultraviolet irradiation,
a*₀ and b*₀ are color coordinates of the polyamideimide film before UV irradiation, and
a*ₙ and b*ₙ are color coordinates of the polyamideimide film on day n of ultraviolet irradiation.

10. The polyamideimide film of claim 1, wherein the UV blocker is comprised in an amount of 0.5% to 20% by weight based on the weight of the polyamideimide resin.

11. The polyamideimide film of claim 1, wherein a yellow index (YI) is 3.0 or less, as measured according to ASTM E313 standard.

12. The polyamideimide film of claim 1, wherein a modulus is 7.0 GPa or more, as measured according to ASTM D882.

13. The polyamideimide film of claim 1, wherein haze is 1.0% or less, as measured according to ASTM D1003.

14. An optical multilayer structure comprising:
the polyamideimide film according to claim 1; and
a hard coating layer formed on the polyamideimide film.

15. The optical multilayer structure of claim 14, wherein the hard coating layer comprises a UV blocker comprising a benzotriazole-based compound.

16. The optical multilayer structure of claim 15, wherein the benzotriazole-based compound comprises one or more compounds selected from the group consisting of the following compounds: 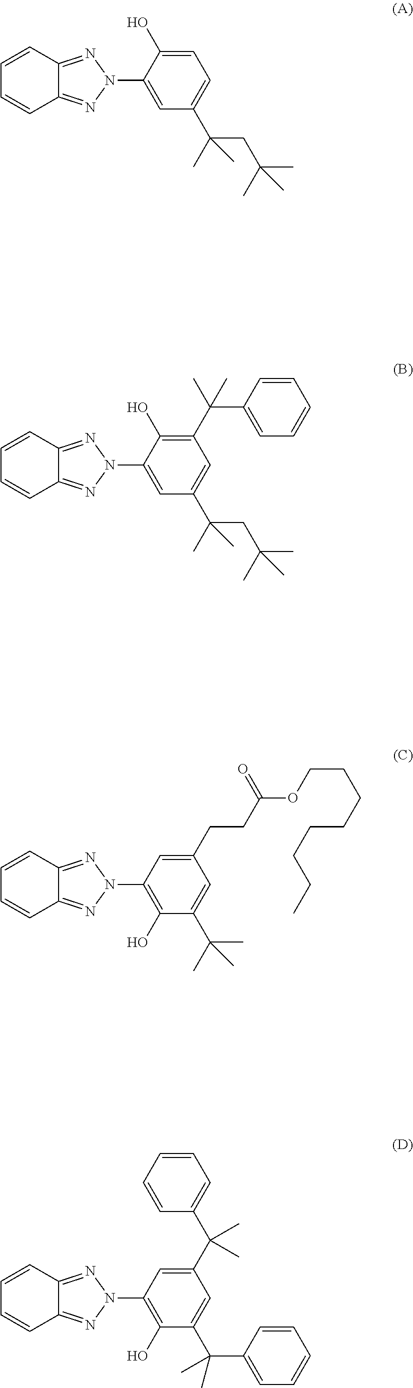 [SMILES: CC(C)(C)CC(C)(C)c1ccc(O)c(-n2nc3ccccc3n2)c1 ; CC(C)(C)CC(C)(C)c1cc(-n2nc3ccccc3n2)c(O)c(C(C)(C)c2ccccc2)c1 ; CCCCCCCCOC(=O)CCc1cc(-n2nc3ccccc3n2)c(O)c(C(C)(C)C)c1 ; CC(C)(c1ccccc1)c1cc(-n2nc3ccccc3n2)c(O)c(C(C)(C)c2ccccc2)c1] 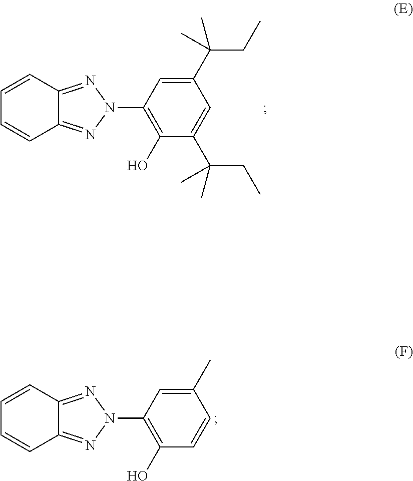 [SMILES: CCC(C)(C)c1cc(-n2nc3ccccc3n2)c(O)c(C(C)(C)CC)c1 ; Cc1ccc(O)c(-n2nc3ccccc3n2)c1]
and mixtures thereof.

17. The optical multilayer structure of claim 15, wherein the benzotriazole-based compound is the following compound:

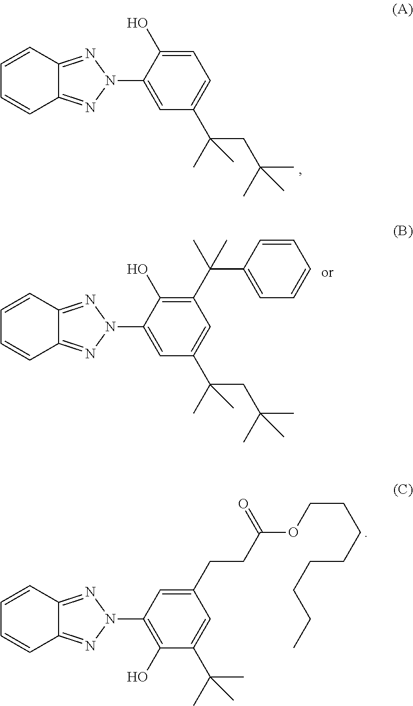 [SMILES: CC(C)(C)CC(C)(C)c1ccc(O)c(-n2nc3ccccc3n2)c1 ; CC(C)(C)CC(C)(C)c1cc(-n2nc3ccccc3n2)c(O)c(C(C)(C)c2ccccc2)c1 ; CCCCCCCCOC(=O)CCc1cc(-n2nc3ccccc3n2)c(O)c(C(C)(C)C)c1]

18. A cover window for a display comprising the optical multilayer structure according to claim 14.
